(19) United States
(12) Patent Application Publication
(10) Pub. No.: US 2021/0291589 A1
(43) Pub. Date: Sep. 23, 2021

(54) PNEUMATIC TIRE

(71) Applicant: Toyo Tire Corporation, ltami-shi, Hyogo (JP)

(72) Inventor: Yuuki Masumoto, Itami-shi (JP)

(73) Assignee: Toyo Tire Corporation, Itami-shi, Hyogo (JP)

(21) Appl. No.: 16/330,535

(22) PCT Filed: Sep. 13, 2017
(86) PCT No.: PCT/JP2017/033012

§ 371 Date: Mar. 5, 2019

(30) Foreign Application Priority Data
Oct. 14, 2016 (JP) 2016-202881

(51) Int. Cl. B60C 1/00; C08L 91/06; C08K 5/098; C08K 5/20; C08L 9/06; C08L 7/00

(52) U.S. Cl. CPC B60C 1/0016; B60C 1/0025; C08L 91/06; C08K 2201/019; C08K 5/20; C08L 9/06; C08L 7/00; C08K 5/098

(57) ABSTRACT

Provided is a pneumatic tire wherein a rubber composition is used in a tread rubber, a sidewall rubber, or a rim strip. The rubber composition contains a diene rubber, a petroleum-derived wax, a fatty acid metal salt and a compound represented by the formula (1) (in the formula, R¹ and R² each represent a hydrogen atom, an alkyl group, an alkenyl group or an alkynyl group, and M⁺ represents N⁺, K⁺, or Li⁺), wherein the amount of a phenylenediamine age resister is less than 1 phr, and a difference obtained by subtracting the number of carbon atoms in a constituent fatty acid contained the most in the fatty acid metal salt from the number of carbon atoms in a hydrocarbon contained the most in the petroleum-derived wax is −10 to 8. Thereby, the pneumatic tire can suppress whitening and discoloration to reddish brown while maintaining ozone resistance and improve appearance.

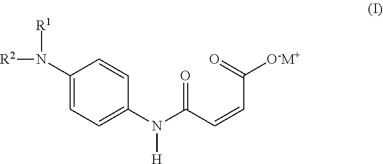

### TECHNICAL FIELD

The embodiment of the present invention relates to a pneumatic tire.

### BACKGROUND ART

Wax and an age resister are added to a rubber composition forming a tread rubber, a sidewall rubber and rim strip of a pneumatic tire in order to suppress deterioration of the rubber composition by ozone and ultraviolet rays in the air. The wax and the age resister have a deterioration suppression effect such as ozone resistance, but on the other hand, discolor a rubber surface to white and reddish brown by blooming on the rubber surface, becoming a factor for poor appearance of the tire. For this reason, the pneumatic tire is required to be suppressed from discoloring to white and reddish brown while maintaining ozone resistance.

To suppress whitening by wax, Patent Literature 1 discloses adding natural wax having a low softening point component and a polar natural wax having a high softening point component to a rubber composition containing a polar rubber, silica and carbon black. The Patent Literature 1 further discloses adding an alkaline fatty acid metal salt such as calcium stearate in order to neutralize an acid contained in an epoxidized natural rubber as a polar rubber. However, the Patent Literature 1 denies using a petroleum-derived wax and does not disclose to adjust the number of carbon atoms of the petroleum-derived wax and the number of carbon atoms of the fatty acid metal salt.

Patent Literature 2 discloses adding a fatty acid metal salt having the number of carbon atoms 16 to 20 smaller than the number of carbon atoms of a hydrocarbon contained the most in wax together with a petroleum-derived wax such as paraffinic wax. However, according to the present inventors' investigations, it was clarified that when the difference in the number of carbon atoms between the fatty acid metal salt and the wax is large, the effect for suppressing whitening is not sufficiently obtained.

Patent Literature 3 discloses adding a mixture of a fatty acid metal salt and a fatty acid ester and wax in a rubber composition for a tire tread. Patent Literature 4 discloses adding wax together with zinc stearate as a release agent in a rubber composition for a sidewall. Patent Literature 5 discloses adding a fatty acid metal salt and wax in a rubber composition for a tire used in a tread, a sidewall and the like. However, those Patent Literatures do not suggest that whitening can be suppressed by adjusting the number of carbon atoms of the wax and the number of carbon atoms of the fatty acid metal salt.

On the other hand, of age resisters, a phenylenediamine age resister is the cause of discoloration to reddish brown. Therefore, the amount of the phenylenediamine age resister added is required to be reduced. However, reduction of the amount of the phenylenediamine age resister is difficult from the standpoint of ozone resistance.

Patent literature 6 discloses adding (2Z)-4-[(4-aminophenyl)amino]-4-oxo-2-butenoic acid salt as a compound bonding carbon black to a diene rubber in order to improve low exothermic property in a rubber composition for a tire of a sidewall and the like. However, the Patent Literature 6 does not disclose that ozone resistance can be maintained while decreasing the amount of a phenylenediamine age register by using the compound.

### CITATION LIST

### Patent Literature

Patent Literature 1: JP-A-2015-017273

Patent Literature 2: JP-A-2014-210830

Patent Literature 3: JP-A-2011-246640

Patent Literature 4: JP-A-2013-018868

Patent Literature 5: JP-A-2011-140612

Patent Literature 6: JP-A-2014-095015

### SUMMARY OF THE INVENTION

### Problems that the Invention is to Solve

In view of the above circumstances, the embodiment of the present invention has an object to provide a pneumatic tire that can suppress whitening and discoloration to reddish brown while maintaining ozone resistance and improve appearance.

### Means for Solving the Problems

The pneumatic tire according to the embodiment is a pneumatic tire having a rubber part formed by a rubber composition containing a diene rubber, a petroleum-derived wax, a fatty acid metal salt and a compound represented by the following formula (I), the rubber part being at least one selected from the group consisting of a tread rubber, a sidewall rubber and a rim strip, wherein the rubber composition does not contain a phenylenediamine age resister or contains the phenylenediamine age resister in an amount of less than 1 part by mass per 100 parts by mass of the diene rubber and a difference (Δ=Cmw−Cmf) obtained by subtracting the number of carbon atoms (Cmf) in a constituent fatty acid contained the most in the fatty acid metal salt from the number of carbon atoms (Cmw) in a hydrocarbon contained the most in the petroleum-derived wax is −10 or more and 8 or less.

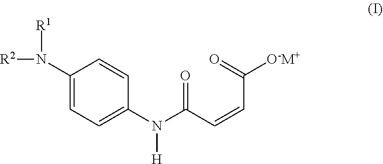

In the formula (1), R¹ and R² represent a hydrogen atom, an alkyl group having 1 to 20 carbon atoms, an alkenyl group having 1 to 20 carbon atoms or an alkynyl group having 1 to 20 carbon atoms, and R¹ and R² may be the same or different. M⁺ represents a sodium ion, a potassium ion or a lithium ion.

### Effects of the Invention

According to the embodiment, by adding the petroleum-derived wax and additionally the fatty acid metal salt having a specific relationship of the number of carbon atoms to the wax, whitening of a rubber surface can be suppressed while maintaining ozone resistance. Furthermore, by adding the compound of the formula (I), the amount of a phenylenediamine age resister added can be reduced and discoloration to reddish brown can be suppressed, while maintaining ozone resistance. As a result, appearance can be improved coupled with suppression of whitening.

### BRIEF DESCRIPTION OF THE DRAWING

FIG. 1 is a half cross-sectional view showing one example of a pneumatic tire.

### MODE FOR CARRYING OUT THE INVENTION

Items relating to the embodiment of the present invention are described in detail below.

The rubber composition for a pneumatic tire according to the embodiment comprises (A) a diene rubber, (B) a petroleum-derived wax, (C) a fatty acid metal salt and (D) a compound represented by the formula (1), and does not contain (E) a phenylenediamine age resister or contains a small amount thereof.

### (A) Diene Rubber

The diene rubber as a rubber component is not particularly limited. Examples of the diene rubber that can be used include natural rubber (NR), isoprene rubber (IR), butadiene rubber (BR), styrene-butadiene rubber (SBR), styrene-isoprene rubber, butadiene-isoprene rubber, styrene-butadiene-isoprene rubber and nitrile rubber (NBR). Those diene rubbers can be used in one kind alone or as mixtures of two or more kinds. The diene rubber is more preferably at least one kind selected from the group consisting of natural rubber, isoprene rubber, styrene-butadiene rubber and butadiene rubber.

As one embodiment, the diene rubber in the rubber composition used in a tread rubber is preferably at least one kind selected from the group consisting of SBR, NR and BR, and may be, for example, SBR alone, a blend of SBR and BR, NR alone or a blend of NR and BR. As one embodiment, the diene rubber in the rubber composition used in a sidewall rubber or s rim strip may be NR alone or a blend of NR and BR.

### (B) Petroleum-Derived Wax

The petroleum-derived wax is called a petroleum wax and is a hydrocarbon wax obtained from petroleum. By adding the petroleum-derived wax, the wax blooms on the rubber surface, thereby imparting ozone resistance. On the other hand, wax becomes the cause of whitening. However, when the wax is the petroleum-derived wax, whitening can be suppressed by using the petroleum-derived wax together with a specific fatty acid metal salt described hereinafter. Ozone resistance is insufficient in wax other than the petroleum-derived wax. Furthermore, whitening suppression effect when the other wax has been used together with the specific fatty acid metal salt is insufficient.

Examples of the petroleum-derived wax include paraffin wax and/or microcrystalline wax. The paraffin wax is wax that is solid at room temperature obtained by separating and extracting from a vacuum distillation distillate part of crude oil, and is a saturated hydrocarbon mainly comprising a linear saturated hydrocarbon (normal paraffin). The microcrystalline wax is wax that is solid at room temperature mainly obtained by separating and extracting from a vacuum distillation residue oil part or a heavy distillate part and is a hydrocarbon containing a large amount of a branched saturated hydrocarbon (isoparaffin) and a saturated cyclic hydrocarbon (cycloparaffin). In one embodiment, the petroleum-derived wax is preferably paraffinic petroleum wax. The paraffinic petroleum wax used herein is wax containing paraffin wax and is preferably paraffin wax or a mixture of parafin wax and microcrystalline wax.

The petroleum-derived wax is generally a mixture containing a hydrocarbon having the number of carbon atoms in a range of 20 to 60 and the petroleum-derived wax having a peak in the carbon number distribution of the hydrocarbon. The number of carbon atoms of the hydrocarbon contained in the petroleum-derived wax is not particularly limited. For example, the number of carbon atoms (Cmw) of the hydrocarbon contained the most in the petroleum-derived wax may be 20 to 50, may be 20 to 40, may be 20 to 35, may be 20 to 30 and may be 22 to 28. The term “the number of carbon atoms of the hydrocarbon contained the most in the petroleum-derived wax” used herein is the number of carbon atoms of the hydrocarbon having the largest mass ratio in hydrocarbons contained in the petroleum-derived wax. The Cmw can be obtained from, for example, a peak top of the carbon number distribution measured using gas chromatography.

The amount of the petroleum-derived wax added is not particularly limited. For example, from the standpoint of ozone resistance, the amount may be 0.1 to 10 parts by mass, may be 0.5 to 5 parts by mass and may be 1 to 3 parts by mass, per 100 parts by mass of the diene rubber.

### (C) Fatty Acid Metal Salt

Fatty acid metal salt is added to the rubber composition according to the embodiment together with the petroleum-derived wax. The fatty acid metal salt may be a mixture of a plurality of fatty acid metal salts.

In the embodiment, fatty acid metal salts satisfying the following requirements are used as the fatty acid metal salt. Specifically, when the number of carbon atoms of the hydrocarbon contained the most in the petroleum-derived wax is Cmw and the number of carbon atoms of the constituent fatty acid contained the most in the fatty acid metal salt is Cmf, the difference Δ (=Cmw−Cmf) obtained by subtracting Cmf from Cmw is −10 or more and 8 or less (−10≤Δ≤8). Thus, it is considered that by using the fatty acid metal salt having the same degree of the number of carbon atoms as the number of carbon atoms of the petroleum-derived wax as a main component, the petroleun-derived wax bloomed on the rubber surface is inhibited from crystallizing, the wax forms a uniform, thin and smooth film, and as a result, whitening is difficult to occur. When Δ>8, the difference in the number of carbon atoms between the fatty acid metal salt and the petroleum-derived wax is large and the effect of suppressing whitening is not sufficiently obtained. On the other hand, when Δ<−10, the number of carbon atoms of the fatty acid metal salt is too large as compared the number of carbon atoms of the petroleum-derived wax and the effect of suppressing whitening is insufficient. The difference Δ is preferably −5 to 6 and more preferably −3 to 6 and may be −1 to 5.

The term “constituent fatty acid” used herein is a fatty acid constituting the fatty acid metal salt. The term “the number of carbon atoms (Cmf) of the constituent fatty acid contained the most in the fatty acid metal salt” is the number of carbon atoms of the fatty acid having the largest molar ratio in fatty acids constituting the fatty acid metal salt. The fatty acid constituting the fatty acid metal salt generally comprises a single fatty acid or a plurality of fatty acids having different number of carbon atoms. In the case of the fatty acid metal salt in which the constituent fatty acid comprises only one kind, the number of carbon atoms (Cmf) of the constituent fatty acid contained the most in the fatty acid metal salt is the number of carbon atoms of the one kind of the constituent fatty acid. Furthermore, when the fatty acid metal salt is a mixture of a plurality of fatty acid metal salts. Cmf is the number of carbon atoms of the fatty acid having the largest molar ratio in all of the fatty acids constituting a plurality of the fatty acid metal salts. Cmf is obtained by, for example, converting the fatty acid metal salt into fatty acid ester by reaction pyrolysis by tetramethylammonium hydroxide and obtaining the fatty acid having the largest molar ratio from a content ratio of each fatty acid obtained by analyzing with gas chromatograph-mass spectrometry (GC/MS).

The number of carbon atoms (Cmf) of the constituent fatty acid contained the most in the fatty acid metal salt is preferably larger than 18. By this, the whitening suppression effect can be enhanced. The Cmf is preferably larger than 20 and more preferably 22 or more. The upper limit of the Cmf is not particularly limited, but may be 30 or less.

Examples of the fatty acid (constituent fatty acid) constituting the fatty acid metal salt include various saturated fatty acids and/or unsaturated fatty acids, having the number of carbon atoms in which the difference Δ to the number of carbon atoms of the hydrocarbon contained the most in the petroleum-derived wax is −10 to 8. Specific examples of the fatty acid include myristic acid (the number of carbon atoms 14), pentadecanoic acid (the number of carbon atoms 15), palmitic acid (the number of carbon atoms 16), heptadecanoic acid (the number of carbon atoms 17), stearic acid (the number of carbon atoms 18), arachidic acid (the number of carbon atoms 20), behenic acid (the number of carbon atoms 22), lingnoceric acid (the number of carbon atoms 24), cerotic acid (the number of carbon atoms 26), montanic acid (the number of carbon atoms 28) and melissic acid (the number of carbon atoms 30). Those can be used in one kind alone or mixtures of two or more kinds. Fatty acids having the number of carbon atoms smaller than that of those fatty acids and/or fatty acids having the number of carbon atoms larger than that of those fatty acids may be contained as the constituent fatty acid so long as the requirement of the difference Δ described above is satisfied.

Examples of the metal in the fatty acid metal salt include an alkali metal salt such as sodium salt (Na) or potassium salt (K), an alkaline earth metal salt such as magnesium salt (Mg) or calcium salt (Ca) and a transition metal salt such as cobalt salt (Co) or copper salt (Cu). Of those, the alkali metal salt and/or the alkaline earth metal salt are preferred and sodium salt and/or calcium salt are more preferred.

The amount of the fatty acid metal salt added is not particularly limited, but from the standpoint of enhancement of the effect of suppressing whitening by the petroleum-derived wax, the amount is preferably 0.5 to 10 parts by mass and more preferably 1 to 8 parts by mass, per 100 parts by mass of the diene rubber. The amount may be 2 to 5 parts by mass.

### (D) Compound Represented by Formula (I)

The compound represented by the following formula (I) is added to the rubber composition of the embodiment. This compound acts as a radical scavenger and therefore, the amount of an age resister can be decreased. By decreasing the amount of a phenylenediamine age resister, reddish brown due to the age resister can be suppressed and appearance of tire can be improved coupled with the effect of suppressing whitening.

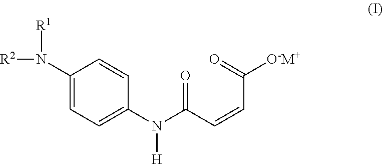

In the formula (I), R¹ and R² represent a hydrogen atom, an alkyl group having 1 to 20 carbon atoms, an alkenyl group having 1 to 20 carbon atoms or an alkynyl group having 1 to 20 carbon atoms. R¹ and R² may be the same or different.

Examples of the alkyl group in R¹ and R² include methyl group, ethyl group, n-propyl group, isopropyl group, n-butyl group, sec-butyl group and tert-butyl group. Examples of the alkenyl group in R¹ and R² include vinyl group, allyl group, 1-propenyl group and 1-methylethenyl group. Examples of the alkynyl group in R¹ and R² include ethynyl group and propargyl group. The number of carbon atoms of those alkyl group, alkenyl group and alkynyl group is preferably 1 to 10 and more preferably 1 to 5. R¹ and R² are preferably a hydrogen atom or an alkyl group having 1 to 5 carbon atoms, more preferably a hydrogen atom or methyl group and still more preferably a hydrogen atom. In one embodiment, —NR¹R² in the formula (I) is preferably —NH₂, —NHCH₃ or —N(CH₃)₂ and more preferably —NH₂.

M⁺ in the formula (I) is sodium ion, potassium ion or lithium ion and is preferably sodium ion.

The amount of the compound represented by the formula (I) added is not particularly limited, but is preferably 0.1 to 10 parts by mass and more preferably 0.5 to 8 parts by mass, per 100 parts by mass of the diene rubber from the standpoint of maintaining ozone resistance while decreasing the amount of the phenylenediamine age resister. The amount may be 1 to 5 parts by mass.

### (E) Phenylenediamine Age Resister

The rubber composition according to the embodiment does not contain a phenylenediamine age resister, or when containing the phenylenediamine age resister, the amount thereof is less than 1 part by mass per 100 parts by mass of the diene rubber. Thus, by decreasing the amount of the phenylenediamine age resister added, the rubber surface can be suppressed from discoloring to reddish brown.

Examples of the phenylene diamine age resister include p-phenylenediamine age resisters such as N-(1,3-dimethylbutyl)-N′-phenyl-p-phenylenediamine (6PPD), N-isopropyl-N′-phenyl-p-phenylenediamine (IPPD), N,N′-diphenyl-p-phenylenediamine (DPPD), N,N′-di-2-naphthyl-p-phenylenediamine (DNPD), N-(3-methacryloyloxy-2-hydroxypropyl)-N′-phenyl-p-phenylenediamine, N-cyclohexyl-N′-phenyl-p-phenylenediamine and N-(1-methylheptyl)-N′-phenyl-p-phenylenediamine.

In the embodiment, the amount of the phenylenediamine age resister becoming the factor of reddish brown can be decreased by adding the compound of the formula (I) having the radical scavenging effect. For this reason, the content of the phenylenediamine age resister is preferably small as possible. For example, the content is preferably 0.5 parts by mass or less per 100 parts by mass of the diene rubber and more preferably the age resister is not contained.

The amount of the age resister can be decreased by the addition of the compound of the formula (I). The content of an aromatic secondary amine age resister is preferably less than 1 part by mass and more preferably 0.5 parts by mass or less, per 100 parts by mass of the diene rubber and still more preferably the age resister is not contained. The content of an amine age resister is preferably less than 1 part by mass and more preferably 0.5 parts by mass or less, per 100 parts by mass of the diene rubber and still more preferably the age resister is not contained. The content of a chemical age resister is preferably less than 1 part by mass and more preferably 0.5 parts by mass or less, per 100 parts by mass of the diene rubber and still more preferably the age resister is not contained. The aromatic secondary amine age resister used herein is a concept including a diphenylamine age resister (for example, 4,4′-bis(α,α-dimethylbenzyl)diphenylamine (CD), octylated diphenylamine (ODPA) or styrenated diphenylamine), a naphthylamine age resister (for example, N-pheuyl-1-nahthylamine (PAN) or N-phenyl-2-naphthylamine (PBN) and the like), in addition to the phenylenediamine age resister. The amine age resister is a concept including an amine-ketone age resister (for example, 2,2,4-trimethyl-1,2-dihydroquinoline polymer (TMDQ), 6-ethoxy-2,2,4-trimethyl-1,2-dihydro-quinoline (ETMDQ) or a reaction product of diphenylamine and acetone (ADPAL) and the like), in addition to the aromatic secondary amine age resister. The chemical age resister is a concept including a phenol age resister and the like, in addition to the amine age resister.

### (F) Other Components

The rubber composition according to the embodiment can contain various additives generally used in a rubber composition for a tire, such as a filler, zinc flower, stearic acid, a process oil, a vulcanizing agent and a vulcanization accelerator, in addition to the above components.

Carbon black and/or silica can be added as the filler. Carbon black is not particularly limited and can use furnace carbon black of various grades such as SAF grade (N100 Series), ISAF grade (N200 Series), HAF grade (N300 Series) and FEF grade (N500 Series) (those are ASTM grade) as a rubber reinforcer. The silica is not particularly limited, but wet silica is preferably used. The amount of the filler added is not particularly limited, but is preferably 10 to 150 parts by mass, more preferably 20 to 120 parts by mass and still more preferably 30 to 100 parts by mass, per 100 parts by mass of the diene rubber. As one embodiment, the amount of the carbon black added may be 10 to 120 parts by mass and may be 20 to 100 parts by mass, per 100 parts by mass of the diene rubber. The amount of the silica added may be 10 to 120 parts by mass and may be 20 to 100 parts by mass, per 100 parts by mass of the diene rubber.

When the silica is added as the filler, a silane coupling agent such as sulfide silane or mercaptosilane may be added in order to further improve dispersibility of the silica. The amount of the silane coupling agent added is not particularly limited, but is preferably 2 to 20 mass % based on the mass of the silica added.

Examples of the vulcanizing agent include sulfurs such as powdered sulfur, precipitated sulfur, colloidal sulfur, insoluble sulfur and highly dispersible sulfur. The amount of the vulcanizing agent added is not particularly limited. The amount may be 0.1 to 10 parts by mass and may be 0.5 to 5 parts by mass, per 100 parts by mass of the diene rubber. The amount of the vulcanization accelerator added is preferably 0.1 to 7 parts by mass and more preferably 0.5 to 5 parts by mass, per 100 parts by mass of the diene rubber.

The rubber composition can be prepared by kneading according to the conventional method using a mixing machine generally used such as Banbury mixer, a kneader or rolls. For example, other additives excluding a vulcanizing agent and a vulcanization accelerator are added to a diene rubber together with a petroleum-derived wax, a fatty acid metal salt and the compound of the formula (I), followed by mixing, in a first mixing step. A vulcanizing agent and a vulcanization accelerator are then added to the mixture thus obtained, followed by mixing, in a final mixing step. Thus, a rubber composition can be prepared.

The pneumatic tire according to the embodiment has a rubber part prepared by the rubber composition and uses the rubber composition in at least one rubber part selected from the group consisting of a tread rubber, a sidewall rubber and a rim strip.

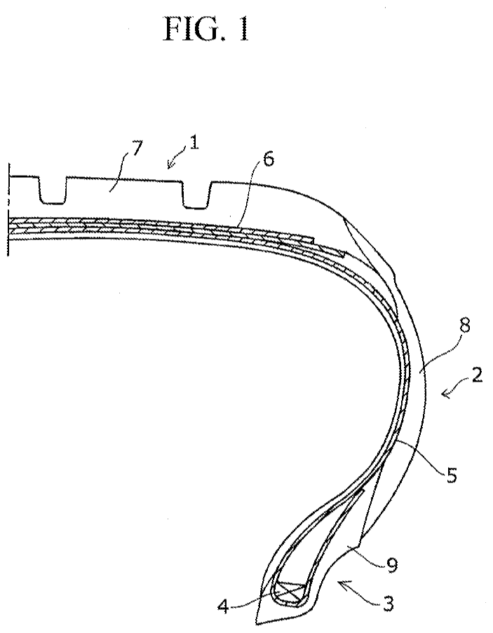

FIG. 1 shows one example of a pneumatic tire. The pneumatic tire comprises a tread part 1, a pair of left and right sidewall parts 2 and a pair of left and right bead parts 3, wherein a carcass ply 5 extending in a toroidal shape is embedded between a pair of bead cores 4 embedded in a pair of the bead parts 3 and a belt 6 is provided at an outer peripheral side in a radial direction of the carcass ply 5 in the tread part 1.

The pneumatic tire has a tread rubber 7, a sidewall rubber 8 and a rim strip 9. The tread rubber 7 is arranged at an outer peripheral side in a radial direction of the belt 6 in the tread part 1 to form a ground-contact surface. The sidewall rubber 8 is arranged at a tire outer surface side of the carcass ply 5 in the sidewall part 2 to form a tire outer surface of the sidewall part 2. The rim strip 9 is arranged so as to cover a contact region with a rim flange in the bead part 3 to form a tire outer surface of the bead part 3. The rim strip 9 is a rubber layer continuously provided outside the bead part 3 at the lower end part of the sidewall rubber 8.

Those tread rubber 7, sidewall rubber 8 and rim strip 9 form an outer surface of a pneumatic tire and are therefore required to suppress discoloration of a rubber surface. For this reason, the rubber composition according to the embodiment is preferably used.

In manufacturing a pneumatic tire, the rubber composition is formed into a predetermined shape by, for example, extrusion processing according to the conventional method to obtain an unvulcanized tread rubber member, an unvulcanized sidewall rubber member and/or an unvulcanized rim strip rubber member. Those members are combined with other parts such as an inner liner, a carcass, a belt, a bead core and a bead filler, thereby manufacturing a green tire (unvulcanized tire). The green tire is then vulcanization-molded at, for example, 140 to 180° C. Thus, a pneumatic tire can be manufactured. In the pneumatic tire according to the embodiment, any one or at least two of a tread rubber, a sidewall rubber and a rim strip are formed by the rubber composition.

The kind of the pneumatic tire according to the embodiment is not particularly limited, and includes various tires such as tires for passenger cars and heavy load tires used in trucks and buses.

### EXAMPLES

Examples of the present invention are described below, and the present invention is not construed as being limited to those examples.

### First Example

Banbury mixer was used. Compounding ingredients excluding sulfur and a vulcanization accelerator were added to a diene rubber according to the formulations (parts by mass) shown in Table 1 below, followed by kneading, in a first mixing step (discharge temperature: 160° C.). Sulfur and a vulcanization accelerator were added to the kneaded product obtained, followed by kneading, in a final mixing step (discharge temperature: 90° C.). Thus, a rubber composition was prepared. The details of each component in Table 1 are as follows.

SBR: Styrene-butadiene rubber, “SBR1723” manufactured by JSR Corporation BR: Butadiene rubber, “BR150” manufactured by Ube Industries, Ltd.

Carbon black 1: HAF, “SEAST 3” manufactured by Tokai Carbon Co., Ltd.

Silica: “NIPSIL AQ” manufactured by Tosoh Silica Corporation

Oil: “JOMO PROCESS NC140” manufactured by JX Nippon Oil & Sun Energy Corporation

Silane coupling agent: “Si75” manufactured by Evonik

Zinc flower: “Zinc Flower #1” manufactured by Mitsui Mining & Smelting Co., Ltd.

Stearic acid: “LUNC S-20” manufactured by Kao Corporation

Age resister 1: N-(1,3-dimethylbutyl)-N′-phenyl-p-phenylenediamine (6PPD), “ANTIGEN 6C” manufactured by Sumitomo Chemical Co., Ltd.

Compound (I): Sodium (2Z)-4-[(4-aminophenyl)amino]-4-oxo-2-butenoate (compound represented by the following formula (I′))

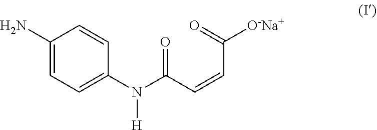

Sulfur: “5% Oil-Treated Powdered Sulfur” manufactured by Tsurumi Chemical Industry Co., Ltd.

Vulcanization accelerator CZ: “SOXINOL CZ” manufactured by Sumitomo Chemical Co., Ltd.

Vulcanization accelerator D: “SANCELLER DM-G” manufactured by Sanshin Chemical Industry Co., Ltd.

Lauric acid Ca: “CS-3” (Cmf: 12) manufactured by Nitto Kasei Kogyo K.K.

Lauric acid Zn: “ZS-3” (Cmf 12) manufactured by Nitto Kasei Kogyo K.K.

Stearic acid Ca: “Calcium Stearate G” (Cmf: 18) manufactured by MOF Corporation Behenic acid Ca: “CS-7” (Cmf 22) manufactured by Nitto Kasei Kogyo K.K.

Behenic acid Na: “NS-7” (Cmf 22) manufactured by Nitto Kasei Kogyo K.K.

Montanic acid Ca: “CS-8” (Cmf 28) manufactured by Nitto Kasei Kogyo K.K.

Wax 1: Petroleum wax (paraffinic petroleum wax), “OZOACE 0355” (Cmw: 27) manufactured by Nippon Seiro Co., Ltd.

Wax 2: Petroleum wax (paraffinic petroleum wax) (Cmw: 32)

Wax 3: Petroleum wax (paraffinic petroleum wax) (Cmw: 23)

Wax 4: Animal wax, “Purified Beewax BEES WAX CO-100” (Cmw: 26) manufactured by Yokozeki Oil & Fat Industries Co., Ltd.

Waxes 2 and 3 are trial waxes having adjusted carbon number distribution obtained by subjecting various commercially available waxes to separation by column using gas chromatography (GC) to separate and collect a wax component having specific number of carbon atoms, combining those wax components and blending those.

Cmw (the number of carbon atoms of hydrocarbon contained the most in wax) was obtained as follows. Capillary gas chromatography (GC) was used as a measurement apparatus. Carbon number distribution of wax was obtained by measuring from 180° C. to 390° C. under the conditions of carrier gas: helium, flow rate: 4 mL/min and temperature rising rate: 15° C./min using a polyimide-coated capillary column, and the number of carbon atoms at a peak top was obtained from the carbon number distribution.

Cmf (the number of carbon atoms of constituent fatty acid contained the most in fatty acid metal salt) can be obtained using reaction pyrolysis GCMS (gas chromatograph-mass spectrometry) method. Here, heating decomposition was conducted at 350° C. using a thermal decomposition apparatus (3030D) manufactured by Frontier Laboratories Ltd. and thermal decomposition GC/MS was measured using GC/MS apparatus (Automass SUN) manufactured by JEOL Ltd. (column used: VA-DX30 manufactured by Frontier Laboratories Ltd., carrier gas: helium, flow rate: 1 mL/min and temperature rising rate: 10° C./min). In this case, a material obtained by adding 2 μL of 25 mass % tetramethylammonium hydroxide/methanol solution to about 200 μg of a sample was used as a measurement sample.

Each rubber composition was vulcanized at 160° C. for 20 minutes to prepare a test piece (thickness: 2 mm), and appearance and ozone resistance were evaluated. Each evaluation test is as follows.

Appearance (whitening): A vulcanized rubber piece was irradiated with sunlight outdoors. The surface of the vulcanized rubber piece after 40 days was visually observed and the appearance (whitening) was evaluated by the following criteria. Appearance is good as the grade is large.

Grade 5: Surface is not substantially discolored white

Grade 4: Surface is lightly discolored white

Grade 3: Less than a half of the whole surface is discolored white

Grade 2: A half or more of the whole surface is discolored white

Grade 1: Surface is totally discolored white

Appearance (reddish brown): A vulcanized rubber piece was irradiated with sunlight outdoors. The surface of the vulcanized rubber piece after 40 days was visually observed and the appearance (reddish brown) was evaluated by the following criteria.

Appearance is good as the grade is large.

Grade 5: Surface is not substantially discolored reddish brown

Grade 4: Surface is lightly discolored reddish brown

Grade 3: Less than a half of the whole surface is discolored reddish brown

Grade 2: A half or more of the whole surface is discolored reddish brown

Grade 1: Surface is totally discolored reddish brown

Ozone resistance: A vulcanized rubber piece was installed in an ozone weather meter under the condition of 25% elongation and was allowed to stand in the environment of ozone concentration of 100 pphm and temperature of 50° C. for 24 hours. Thereafter, generation state of cracks was visually observed and ozone resistance was evaluated by the following criteria. Ozone resistance is good as the grade is large.

Grade 4: No generation of cracks

Grade 3: Cracks that cannot be confirmed with the naked eye but can be confirmed with a magnifying glass of 10 magnifications are generated

Grade 2: Cracks of 1 mm or less are generated

Grade 1: Cracks exceeding 1 mm are generated.

TABLE 1

| | Comparative Example | | | | | | | | | Example | | | | | | |
|---|---|---|---|---|---|---|---|---|---|---|---|---|---|---|---|---|
| | 1 | 2 | 3 | 4 | 5 | 6 | 7 | 8 | 9 | 1 | 2 | 3 | 4 | 5 | 6 | 7 |
| Formulation (parts by mass) | | | | | | | | | | | | | | | | |
| SBR | 70 | 70 | 70 | 70 | 70 | 70 | 70 | 70 | 70 | 70 | 70 | 70 | 70 | 70 | 70 | 70 |
| BR | 30 | 30 | 30 | 30 | 30 | 30 | 30 | 30 | 30 | 30 | 30 | 30 | 30 | 30 | 30 | 30 |
| Carbon black 1 | 35 | 35 | 35 | 35 | 35 | 35 | 35 | 35 | 35 | 35 | 35 | 35 | 35 | 35 | 35 | 35 |
| Silica | 35 | 35 | 35 | 35 | 35 | 35 | 35 | 35 | 35 | 35 | 35 | 35 | 35 | 35 | 35 | 35 |
| Oil | 20 | 20 | 20 | 20 | 20 | 20 | 20 | 20 | 20 | 20 | 20 | 20 | 20 | 20 | 20 | 20 |
| Silane coupling agent | 2.8 | 2.8 | 2.8 | 2.8 | 2.8 | 2.8 | 2.8 | 2.8 | 2.8 | 2.8 | 2.8 | 2.8 | 2.8 | 2.8 | 2.8 | 2.8 |
| Zinc flower | 2 | 2 | 2 | 2 | 2 | 2 | 2 | 2 | 2 | 2 | 2 | 2 | 2 | 2 | 2 | 2 |
| Stearic acid | 2 | 2 | 2 | 2 | 2 | 2 | 2 | 2 | 2 | 2 | 2 | 2 | 2 | 2 | 2 | 2 |
| Age resister 1 | 2 | 2 | 2 | 2 | 2 | 2 | 0.5 | 0.5 | 0.5 | 0.5 | 0.5 | 0.5 | 0.5 | 0.5 | 0.5 | |
| Compound (I) | | | | | | | | 2 | 2 | 2 | 2 | 2 | 2 | 2 | 2 | 2 |
| Lauric acid Ca | | | 3 | | | | | | | | | | | | | |
| Lauric acid Zn | | | | 3 | | | | | | | | | | | | |
| Stearic acid Ca | | | | | 3 | 3 | 3 | 3 | 3 | | | | | | 3 | |
| Behenic acid Ca | | | | | | | | | | 3 | | | | | | 3 |
| Behenic acid Na | | | | | | | | | | | 3 | | | | | |
| Montanic acid Ca | | | | | | | | | | | | 3 | 3 | 3 | | |
| Wax 1 | | 2 | 2 | 2 | 2 | | 2 | 2 | | 2 | 2 | 2 | | | | 2 |
| Wax 2 | | | | | | | | | | | | | 2 | | | |
| Wax 3 | | | | | | | | | | | | | | 2 | 2 | |
| Wax 4 | | | | | | 2 | | | 2 | | | | | | | |
| Sulfur | 2 | 2 | 2 | 2 | 2 | 2 | 2 | 2 | 2 | 2 | 2 | 2 | 2 | 2 | 2 | 2 |
| Vulcanization accelerator CZ | 2 | 2 | 2 | 2 | 2 | 2 | 2 | 2 | 2 | 2 | 2 | 2 | 2 | 2 | 2 | 2 |
| Vulcanization accelerator D | 1 | 1 | 1 | 1 | 1 | 1 | 1 | 1 | 1 | 1 | 1 | 1 | 1 | 1 | 1 | 1 |
| Cmw | — | 27 | 27 | 27 | 27 | 26 | 27 | 27 | 26 | 27 | 27 | 27 | 32 | 23 | 23 | 27 |
| Cmf | — | — | 12 | 12 | 18 | 18 | 18 | 18 | 18 | 22 | 22 | 28 | 28 | 28 | 18 | 22 |
| Δ = Cmw − Cmf | — | — | 15 | 15 | 9 | 8 | 9 | 9 | 8 | 5 | 5 | −1 | 4 | −5 | 5 | 5 |
| Evaluation | | | | | | | | | | | | | | | | |
| Appearance (whitening) | 5 | 1 | 1 | 1 | 2 | 2 | 2 | 2 | 2 | 5 | 5 | 5 | 5 | 4 | 3 | 5 |
| Appearance (reddish brown) | 2 | 2 | 2 | 2 | 2 | 2 | 3 | 3 | 3 | 4 | 4 | 4 | 4 | 4 | 4 | 5 |
| Ozone resistance | 1 | 3 | 3 | 3 | 3 | 2 | 2 | 3 | 3 | 3 | 3 | 3 | 3 | 3 | 3 | 3 |

### Second Example

Banbury mixer was used. A rubber composition was prepared in the same method as in First Example according to the formulations (parts by mass) shown in Table 2 below. The details of each component in Table 2 are as follows (the same materials shown in Table 1 are described as above).

NR: Natural rubber RSS #3

Carbon black 2: FEF, “SEAST SO” manufactured by Tokai Carbon Co., Ltd.

Age resister 2: Amine-ketone type, “ANTIGEN RD-G” manufactured by Sumitomo Chemical Co., Ltd.

Vulcanization accelerator NS: “NOCELER NS-P” manufactured by Ouchi Shinko Chemical Industrial Co., Ltd.

Each rubber composition was vulcanized at 160° C. for 20 minutes to prepare a test piece (thickness: 2 mm), and appearance and ozone resistance were evaluated. Each evaluation test is described above.

TABLE 2

| | Comparative Example | | | | | | | | | Example | | |
|---|---|---|---|---|---|---|---|---|---|---|---|---|
| | 10 | 11 | 12 | 13 | 14 | 15 | 16 | 17 | 18 | 8 | 9 | 10 |
| Formulation (parts by mass) | | | | | | | | | | | | |
| NR | 50 | 50 | 50 | 50 | 50 | 50 | 50 | 50 | 50 | 50 | 50 | 50 |
| BR | 50 | 50 | 50 | 50 | 50 | 50 | 50 | 50 | 50 | 50 | 50 | 50 |
| Carbon black 2 | 50 | 50 | 50 | 50 | 50 | 50 | 50 | 50 | 50 | 50 | 50 | 50 |
| Oil | 10 | 10 | 10 | 10 | 10 | 10 | 10 | 10 | 10 | 10 | 10 | 10 |
| Zinc flower | 3 | 3 | 3 | 3 | 3 | 3 | 3 | 3 | 3 | 3 | 3 | 3 |
| Stearic acid | 2 | 2 | 2 | 2 | 2 | 2 | 2 | 2 | 2 | 2 | 2 | 2 |
| Age resister 1 | 2 | 2 | 2 | 2 | 2 | 2 | 0.5 | | | | | |
| Age resister 2 | 2 | 2 | 2 | 2 | 2 | 2 | 0.5 | 0.5 | 0.5 | 0.5 | 0.5 | 0.5 |
| Compound (I) | | | | | | | | 2 | 2 | 2 | 2 | 2 |
| Lauric acid Ca | | | 3 | | | | | | | | | |
| Lauric acid Zn | | | | 3 | | | | | | | | |
| Stearic acid Ca | | | | | 3 | 3 | 3 | 3 | 3 | | | |
| Behenic acid Ca | | | | | | | | | | 3 | | |
| Behenic acid Na | | | | | | | | | | | 3 | |
| Montanic acid Ca | | | | | | | | | | | | 3 |
| Wax 1 | | 2 | 2 | 2 | 2 | | | 2 | | 2 | 2 | 2 |
| Wax 4 | | | | | | 2 | 2 | | 2 | | | |
| Sulfur | 2 | 2 | 2 | 2 | 2 | 2 | 2 | 2 | 2 | 2 | 2 | 2 |
| Vulcanization accelerator NS | 1 | 1 | 1 | 1 | 1 | 1 | 1 | 1 | 1 | 1 | 1 | 1 |
| Cmw | — | 27 | 27 | 27 | 27 | 26 | 26 | 27 | 26 | 27 | 27 | 27 |
| Cmf | — | — | 12 | 12 | 18 | 18 | 18 | 18 | 18 | 22 | 22 | 28 |
| Δ = Cmw − Cmf | — | — | 15 | 15 | 9 | 8 | 8 | 9 | 8 | 5 | 5 | −1 |
| Evaluation | | | | | | | | | | | | |
| Appearance (whitening) | 5 | 1 | 1 | 1 | 2 | 2 | 2 | 2 | 2 | 5 | 5 | 5 |
| Appearance (reddish brown) | 2 | 2 | 2 | 2 | 2 | 2 | 3 | 3 | 3 | 4 | 4 | 4 |
| Ozone resistance | 1 | 3 | 3 | 3 | 3 | 2 | 1 | 3 | 3 | 3 | 3 | 3 |

As shown in Table 1, as compared with Comparative Example 1 as a control, Comparative Example 2 in which wax was added was that ozone resistance was improved but the rubber surface was whitened and appearance was poor. Comparative Examples 3 and 4 were that the fatty acid metal salt was added together with the wax but the difference Δ in the number of carbon atoms between the fatty acid metal salt and the wax was large and the effect of suppressing whitening was not obtained. As compared with Comparative Examples 3 and 4, Comparative Example 5 was that slight improvement effect was recognized in appearance by adding the fatty acid metal salt having higher number of carbon atoms but the difference Δ in the number of carbon atoms between the fatty acid metal salt and the wax was still large and the improvement effect was insufficient. Comparative Example 6 was that the difference Δ in the number of carbon atoms between the fatty acid metal salt and the wax was small but the wax used was not a petroleum-derived wax and was an animal wax and therefore the effect of suppressing whitening was insufficient and ozone resistance was poor. Comparative Example 7 was that appearance was improved in reddish brown by decreasing the amount of the age resister but ozone resistance was poor. As compared with Comparative Example 7, Comparative Examples 8 and 9 were that ozone resistance was improved by adding the compound (I) but the effect of suppressing whitening was insufficient.

On the other hand, in Examples 1 to 7 in which the fatty acid metal salt was added together with the petroleum-derived wax and the difference Δ in the number of carbon atoms between those was in the specified range and in addition to those, the compound (I) was added and the amount of the age resister was decreased, whitening and reddish brown were suppressed and appearance could be improved, while maintaining ozone resistance.

Furthermore, whitening and reddish brown could be suppressed and appearance could be improved while maintaining ozone resistance, by adding the petroleum-derived wax and the fatty acid metal salt and specifying the difference Δ in the number of carbon atoms between those to the specified range, and in addition to those, by adding the compound (I) and decreasing the amount of the phenylenediamine age resister even in the NR/BR series in Table 2, similar to the SBRBR series in Table 1.

Table 1 is the formulation for a tread and Table 2 is the formulation for a sidewall. The formulation for a rim strip is that the composition and the like of the rubber component as a base are common to the formulation for a sidewall. Therefore, it could be easily understood by one skilled in the art that the same effect is obtained even in the formulation for a rim strip.

### DESCRIPTION OF REFERENCE NUMERALS AND SIGNS

7 Tread rubber
8 Sidewall rubber
9 Rim strip

1. A pneumatic tire having a rubber part formed by a rubber composition comprising a diene rubber, a petroleum-derived wax, a fatty acid metal salt and a compound represented by the following formula (1), the rubber part being at least one selected from the group consisting of a tread rubber, a sidewall rubber and a rim strip, wherein the rubber composition does not contain a phenylenediamine age resister or contains the phenylenediamine age resister in an amount of less than 1 part by mass per 100 parts by mass of the diene rubber and a difference (Δ=Cmw−Cmf) obtained by subtracting the number of carbon atoms (Cmf) in a constituent fatty acid contained the most in the fatty acid metal salt from the number of carbon atoms (Cmw) in a hydrocarbon contained the most in the petroleum-derived wax is −10 or more and 8 or less: 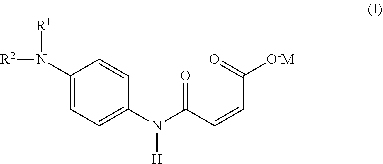
wherein, R¹ and R² represent a hydrogen atom, an alkyl group having 1 to 20 carbon atoms, an alkenyl group having 1 to 20 carbon atoms or an alkynyl group having 1 to 20 carbon atoms, R¹ and R² may be the same or different, and M⁺ represents a sodium ion, a potassium ion or a lithium ion.

2. The pneumatic tire according to claim 1, wherein the number of carbon atoms in the constituent fatty acid contained the most in the fatty acid metal salt is larger than 18.

3. The pneumatic tire according to claim 1, wherein the difference (Δ=Cmw−Cmf) is −5 or more and 6 or less.

4. The pneumatic tire according to claim 1, wherein the rubber composition comprises 100 parts by mass of the diene rubber, 0.1 to 10 parts by mass of the petroleum-derived wax, 0.5 to 10 parts by mass of the fatty acid metal salt and 0.1 to 10 parts by mass of the compound represented by the formula (I).

5. The pneumatic tire according to claim 1, wherein the petroleum-derived wax is paraffin wax and/or microcrystalline wax.
